(19) United States
(12) Patent Application Publication
(10) Pub. No.: US 2003/0123987 A1
(43) Pub. Date: Jul. 3, 2003

(54) Axial flow fan with noise reducing means

(76) Inventor: Claude Marcel Louis Longet, Lyon (FR)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/308,931

(22) Filed: Dec. 3, 2002

(30) Foreign Application Priority Data
Dec. 3, 2001 (FR) 01 15680

(51) Int. Cl. F03B 3/12

(52) U.S. Cl. 416/223 R; 416/228

(57) ABSTRACT

The invention relates to an axial flow fan comprising a wheel having a plurality of blades (1) rotatably mounted within and at distance of at least a casing (4), each blade (1) being provided with an acoustic noise reducing means (10) at the vicinity of the casing (4), characterized in that the noise reducing means (10) are provided at the downstream face (I) of the blades (1) and made by a fold of material (10A) forming an outgrowth relatively to the surface of each blade (1) and whose external face (12) forming the outline is approximately tangential to the tip of each blade at its upper part.

Industrial fans.

The present invention concerns the technical field of axial flow type fans, comprising a wheel composed of a series of blades mounted in rotation inside of and at a distance from a shell forming the housing of the fan.

The present invention concerns an axial flow fan comprising a wheel composed of a series of blades mounted in rotation inside of and at a distance from a shell, each blade being fitted with an acoustic noise reducing means fixed near the shell.

Axial flow fans are widely known and comprise a fan wheel formed by a series of blades of fixed or variable pitch, attached to a hub, the wheel being supported and driven by a drive shaft integral with a motor intended to furnish the energy needed for the rotation of the shaft.

The wheel and the blades are located inside a housing or shell, and are mounted at a precise distance, on the order of a few millimeters, from the inner face of the shell.

In order to reduce the acoustic power of the fan, it is already known to reduce as much as possible the peripheral clearance between the end of the blades and the inner surface of the shell. In effect, the rotation of the wheel creates a difference in pressure between the lower surface and the upper surface of each blade, which generates a circulation of fluid around the ends of the blades, through the annular area corresponding to the peripheral clearance between the end of the blades and the inner face of the shell.

The circulation of fluid due to the difference in pressure generates strong turbulences that are the source of noise and which contribute significantly to the genesis of the acoustic power of the axial flow fan.

In order to reduce the acoustic power of this type of fan, it is already known-to reduce as much as possible the above-mentioned peripheral clearance, while attempting to obtain a shell that is sufficiently rigid and perfectly round. To resolve this problem, it is already known to use rigid materials for the materials that comprise the shell, and to make a shell that is quite thick, the inner face of which is generally machined by lathe in an attempt to produce a perfectly cylindrical shape. In the same way, to reduce the peripheral clearance, the wheel itself is machined around its axis, after assembling the blades on the hub. In some cases, the shell of the fan is made in the form of two independent shells assembled to each other, one of the shells consisting of and supporting the assembly of the arms and support of the drive motor on the shaft end of which is attached the wheel of the fan. The use of two shells has the advantage of facilitating the centering of the second shell, while also facilitating its method of assembly.

However, all of the forms of embodiment mentioned above have the disadvantage of being expensive because their production requires numerous successive industrial steps, including machining and assembly in particular, as well as the consumption of a relatively large amount of materials. Furthermore, the known devices still have the disadvantage of producing relatively strong turbulences that generate acoustic noise.

Consequently, the purpose of the invention is to resolve all of the above-mentioned problems and to propose a new axial flow fan of particularly simplified design and production, and which makes an effective contribution to reducing the acoustic power of such fans.

Another purpose of the invention is to propose a new axial flow fan that also has improved overall performance.

Another purpose of the invention is to propose a new axial flow fan that is particularly economical to produce.

Another purpose of the invention is to propose a new axial flow fan for which the manufacturing is particularly simplified.

These purposes of the invention are achieved by means of an axial flow fan comprising a wheel composed of a series of blades mounted in rotation inside of and at a distance from at least one shell, each blade being fitted with an acoustic noise reducing means placed near the shell, characterized in that the noise reducing means are fixed on the lower surface of the blades and are formed by a ridge of material forming a protrusion with reference to the surface of each blade and the outer face of which forms the contour and is appreciably tangent to the end of each blade at its upper part.

Other features and advantages of the invention will be better understood from the following non-limiting description and appended drawings, given purely by way of illustration, in which:

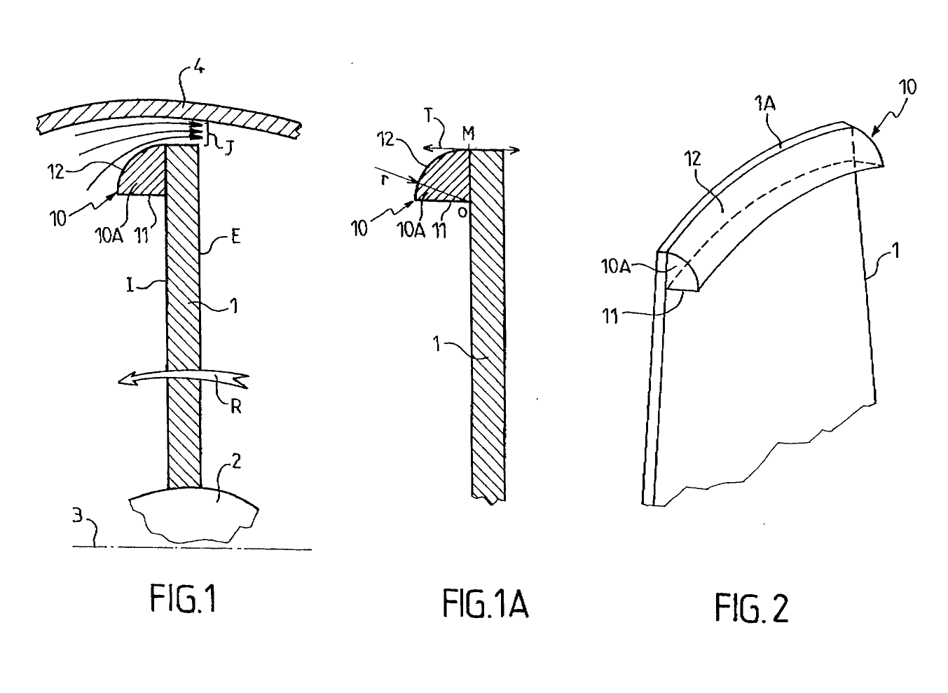

FIG. 1 is a partial transversal cross-sectional view illustrating one preferable form of embodiment of an axial flow fan blade according to the invention.

FIG. 1A illustrates a view and a variation of embodiment identical to the variation in FIG. 1, in which additional references have been added for greater clarity.

FIG. 2 is a partial perspective view illustrating an axial flow fan blade according to the invention having a noise reducing means extending the full width of the blade.

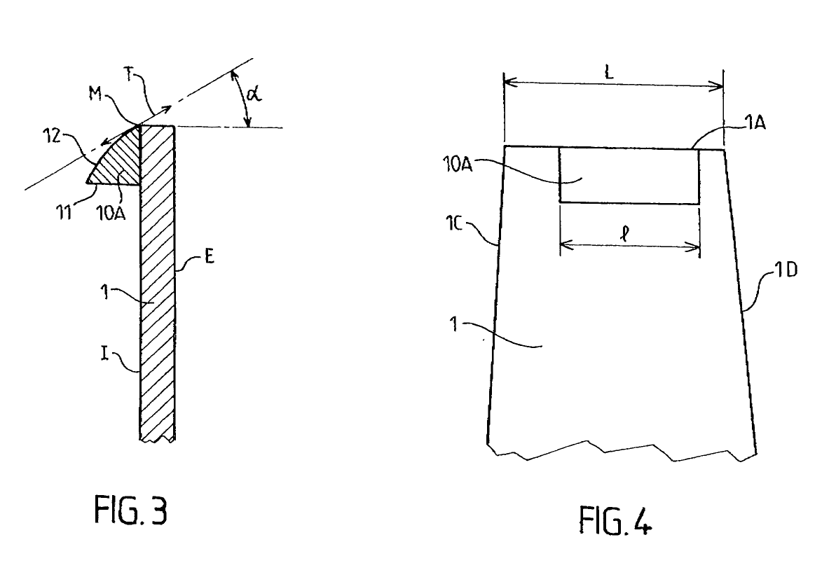

FIG. 3 is a partial transversal cross-sectional view illustrating another variation of embodiment of an axial flow fan blade according to the invention.

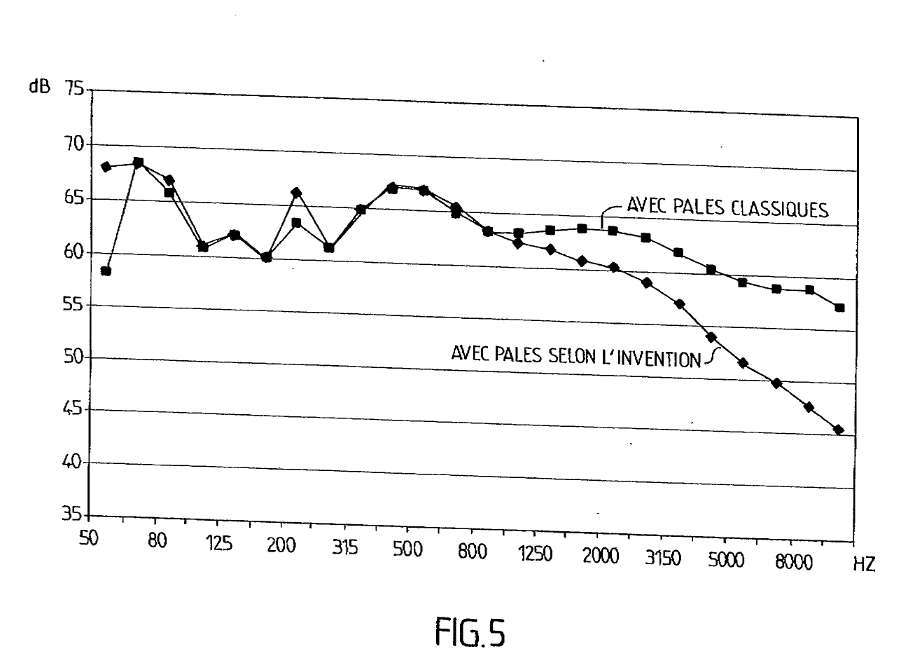

FIG. 4 is a partial side view illustrating another variation of embodiment of an axial flow fan blade according to the invention.

FIG. 5 shows a graph providing a comparative representation of the acoustic power gain of an axial flow fan equipped with blades according to the invention, compared to an axial flow fan equipped with traditional blades with no noise reducing means.

FIG. 1 represents a blade 1 of an axial flow fan (not represented in its entirety) according to the invention, produced for example from a metal or plastic material, such as by injection, the blade being attached, by any means known to a person of the art, to a hub 2, which in turn is integral with a transmission shaft of which only the geometric axis 3 has been represented for sake of convenience. The transmission shaft is connected to an electric or thermal motor (not shown in the figures) intended to drive the fan.

In a known way, the axial flow fan according to the invention is an industrial fan and has a wheel composed or formed of a series of fixed or variable pitch blades 1 that are star-mounted on the hub 2 at regular or irregular intervals, depending on the configurations chosen. The blades are mounted in rotation inside of and at a distance from at least one shell 4, generally cylindrical, forming the housing of the an axial flow fan.

Preferably, the blades have a solid structure with a thin trailing edge.

The direction of rotation R of the axial flow fan defines for each blade a lower surface I and an upper surface E, as illustrated in FIG. 1.

According to the invention, each blade is provided with an acoustic noise reducing means 10 placed near to the shell 4, and therefore to the clearance J determined by the distance from the upper end 1A of each blade 1, the noise reducing means 10 being fixed on the lower surface I of the blades 1, and formed by a ridge 10A of material forming a protrusion with reference to the surface of each blade 1 and the outer face 12 of which forms the contour and is appreciably tangent to the upper end 1A of each blade 1, so as to obtain an area of continuity of flow for the fluid or gas.

As used here, “ridge” designates a solid protrusion the cross section of which extends appreciably equivalent or comparable along two directions of the space, which is not the case for the cross section of an aileron, for example.

This particular arrangement makes it possible to avoid having to use additional industrial finish steps to reduce the clearance J, while still preserving a significantly decreased level of acoustic power.

Indeed, by placing a blade-end protrusion that is tangential to the end 1A of each blade at its upper part allows the fluid or gas to flow steadily and without significant turbulence around the end 1A of the blades, which explains the decrease in the fan's acoustic noise level.

As used here, “tangential” designates the fact that the contour creates a convergent path to the end 1A of each blade.

In a particularly advantageous way, as illustrated in the figures, the ridge of material 10A forming the noise reducing means 10 will have at its lower part a face 11 for blocking the escape of air, this face 11 extending appreciably radially from the lower surface I. The principal advantage of such an arrangement is that it does not significantly reduce the performance of the fan, but rather preserves an acceptable performance and can even improve it.

In a particularly advantageous way, the ridge 10A has a cross section appreciably in the shape of a quarter circle, the curved part 12 of which is tangential to the end 1A of the blade which corresponds to the trailing edge and the lower free face of which forms the blocking face 11. According to this preferential embodiment, the ridge 10A is attached against the lower surface I, its center O being situated in the joint plane of the blade 1 and the ridge 10A, the intersect M (FIG. 1A) of the ridge with the upper end 1A forming a tangent T. According to this configuration, the blocking face 11 extends appreciably perpendicular straight to the lower surface I.

As illustrated in FIG. 2 in particular, the cross section of the ridge 10A is appreciably constant. As a variation, however, the cross section of the ridge 10A can vary, regularly or not, along its full length.

The variation of embodiment illustrated in FIG. 4 shows that the ridge 10A can follow the end 1A of the blade for a length l that is less than the length L of the end of each blade, without going beyond the scope of the invention. Preferably, the ridge 10A follows the blade end for at least 50% of its width L, and preferably along its full width L. The ridge 10A can start at a distance from the leading edge 1C and stop at a distance from the trailing edge 1D.

Appropriately, the thickness of the ridge 10A will be between 0.5 and 3 times the thickness of each blade, and preferably between 0.5 and 2 times the thickness of blade 1.

The attachment of the ridge 10A to the lower surface of the blades 1 can be achieved in various ways. For example, the ridge 10A can be mounted on each blade by any known means, such as thermal welding, gluing, bolting or other method.

It is also possible for the ridge 10A to be made as one piece with the blade 1, for example by a plastic injection step, or by aluminum molding.

The manufacture of an axial flow fan according to the invention is thus particularly simple and economical, because only the following operations need to be performed:

1. Formation of the ridge 10A, for example along with the blade 1 by injection,

2. Positioning of each blade according to the selected blade angle on the hub 2,

3. Contour milling of the blades, so that their trailing edges are consistent with a surface corresponding to the shape of the shell.

It will be noted that the solid (or compact) nature of the ridge allows step 1 of the process of manufacturing the blades to be standardized. The adaptation of the shape of the trailing edge to the blade angle and to the shape of the shell then only has to be done at the end of the process (step 3 for example). In the form of embodiment shown, the axial flow fan has a single shell 4, it being understood that the axial flow fan according to the invention can have a greater number of shells.

FIG. 3 shows a variation of embodiment according to the invention, in which the curved part 12 forming the contour of the section of the ridge 10A defines any type of convex curve, from where it has a tangent T at the intercept M with the terminal section or the upper end 1A of the blade 1, while determining an angle α that is less than or equal to 30°, for example.

The graph illustrated in FIG. 5 shows the particularly interesting noise reduction results obtained with an axial flow fan equipped with blades according to the invention.

Indeed, a reading of this graph confirms a consequent reduction in acoustic noise, particularly the broadband noise of the fan, said reduction increasing steadily with the increase of the frequency of the noise. The reduction can reach 10 dB for the 10,000 Hz third-octave.

1. Axial flow fan comprising a wheel composed of a series of blades (1) mounted in rotation inside of and at a distance from at least one shell (4), each blade (1) being fitted with an acoustic noise reducing means (10) near the shell (4), characterized in that the noise reducing means (1) are fixed on the lower surface (I) of the blades (1) and are formed by a ridge of material (10A) forming a protrusion with reference to the surface of each blade 91) and the outer face (12) of which forms the contour and is appreciably tangent to the end (1A) of each blade at its upper part.

2. Fan according to claim 1, characterized in that the contour (12) defines a convex curve having a tangent (The) at the intersect with the end (1A) while determining an angle α that is less than or equal to 30°.

3. Fan according to claims 1 or 2, characterized in that the ridge (10A) has at its lower part a face (11) for blocking the escape of air.

4. Fan according to any of claims 1 to 3, characterized in that the ridge (10A) has a cross section appreciably in the shape of a quarter circle, the curved part (12) of which is tangential to the end (1A) of the blade which corresponds to the trailing edge and the lower free face of which forms the blocking face (11).

5. Fan according to any of claims 1 to 4, characterized in that the cross section of the ridge (10A) is appreciably constant.

6. Fan according to any of claims 1 to 5, characterized in that the ridge (10A) follows the end (1A) of the blade (1) for at least 50% of its width.

7. Fan according to claim 6, characterized in that the ridge (10A) follows the end (1A) of the blade (1) for its full width.

8. Fan according to claim 6, characterized in that the ridge (10A) can start at a distance from the leading edge (1C) and stop at a distance from the trailing edge (1D) of each blade (1).

9. Fan according to any of claims 1 to 8, characterized in that the thickness of the ridge (10A) will be between 0.5 and 3 times the thickness of each blade (1), and preferably between 0.5 and 2 times the blade thickness.

10. Fan according to any of claims 1 to 9, characterized in that the ridge (10A) can be mounted on each blade (1).

11. Fan according to any of claims 1 to 9, characterized in that the ridge (10A) is made as one piece with the blade (1), for example by injection.

12. Fan according to any of claims 1 to 11, characterized in that it has a single shell (4).
